(19) United States
(12) Patent Application Publication
(10) Pub. No.: US 2023/0420159 A1
(43) Pub. Date: Dec. 28, 2023

(54) Composite Conducting Element, Power Line and Manufacturing Process of Composite Conducting Element

(71) Applicant: Guangdong Rifeng Electric Cable Co., Ltd., Zhongshan (CN)

(72) Inventors: Qiang Li, Zhongshan (CN); Jiqiang Bao, Zhongshan (CN); Mingkui Wang, Zhongshan (CN)

(21) Appl. No.: 17/895,242

(22) Filed: Aug. 25, 2022

(30) Foreign Application Priority Data
Jun. 28, 2022 (CN) 202210743420.3

(51) Int. Cl. H01B 9/02; H01B 9/00; H01B 13/00

(52) U.S. Cl. CPC H01B 9/02; H01B 9/006; H01B 13/0026

(57) ABSTRACT

A composite conducting element, a power line and a manufacturing process of the composite conducting element. The composite conducting element includes a non-woven fabric layer, at least one wire body and a conducting layer component. The wire body is arranged on at least one surface of the non-woven fabric layer and the wire body extends along a length direction of the non-woven fabric layer. The conducting layer component covers at least one surface of the non-woven fabric layer and the wire body is located between the conducting layer component and the non-woven fabric layer. The wire body is conductively connected with the conducting layer component and a conductor wire in the power line is coated with the composite conducting element.

### CROSS-REFERENCE TO RELATED APPLICATION

This application claims priority to Chinese Patent Application No. 202210743420.3 filed Jun. 28, 2022, the disclosure of which is hereby incorporated by reference in its entirety.

### BACKGROUND

### Technical Field

The present disclosure relates to the technical field of cables, and more particularly, to a composite conducting element, a power line and a manufacturing process of the composite conducting element.

### Technical Description

For an existing power cable, in order to increase a safety level, an electric leakage detection layer may be sleeved on a conductor wire inside the power cable. The electric leakage detection layer is generally a conducting layer composed of an aluminum foil layer or a metal braid layer, and the electric leakage detection layer is connected through an electric leakage detection circuit. In the case of electric leakage of the conductor wire inside the power cable, the electric leakage detection circuit detects electricity on the electric leakage detection layer, so as to make corresponding actions.

However, the aluminum foil layer has relatively poor toughness and is easy to be torn when the power cable is bent, and the broken aluminum foil layer loses an electric leakage detection capability, while the metal braid layer has relatively poor conductivity and a troublesome manufacturing process at the same time, so that production efficiency is low.

### SUMMARY

The present disclosure aims to address at least one of the technical problems in the existing technology. Therefore, the present disclosure provides a composite conducting element, a power line and a manufacturing process of the composite conducting element, the composite conducting element has high toughness and conductivity, the power line has good electric leakage detection performance and is safe to use, and the manufacturing process of the composite conducting element is simple and can improve production efficiency.

A composite conducting element according to an embodiment in a first aspect of the present disclosure comprises: a non-woven fabric layer; at least one wire body arranged on at least one surface of the non-woven fabric layer, the wire body extending along a length direction of the non-woven fabric layer; and a non-metallic conducting layer component covering at least one surface of the non-woven fabric layer, the wire body being located between the conducting layer component and the non-woven fabric layer, and the wire body being conductively connected with the conducting layer component.

The composite conducting element according to the embodiment of the present disclosure at least has the following beneficial effects.

For the composite conducting element according to the present disclosure, the non-woven fabric layer has a good toughness, and the non-metallic conducting layer component covers the non-woven fabric layer. When the composite conducting element is bent, the non-woven fabric layer is not easy to be torn, and the conducting layer component can be well supported at the same time, so that the conducting layer component keeps a good conductivity, and the wire body can also be tightly contacted with the conducting layer component. Therefore, an electrical signal induced by the conducting layer component can be transmitted to the outside through the wire body.

According to some embodiments of the present disclosure, the conducting layer component comprises a first conducting layer and a second conducting layer, the first conducting layer covers an upper surface of the non-woven fabric layer, the second conducting layer covers a lower surface of the non-woven fabric layer, the wire body is located between the second conducting layer and the non-woven fabric layer, and the wire body is conductively connected with the second conducting layer.

According to some embodiments of the present disclosure, the conducting layer component is composed of one of superconducting graphene, superconducting carbon nanometer, superconducting graphite or superconducting carbon black.

A power line according to an embodiment in a second aspect of the present disclosure is internally provided with at least two conductor wires, wherein a partial or whole outer peripheral surface of each conductor wire is coated with the composite conducting element according to any one of the embodiments above.

The power line according to the embodiment of the present disclosure at least has the following beneficial effects.

For the power line according to the present disclosure, two conductor wires may be connected to two electrodes of a direct-current power supply or two phases of an alternating-current power supply respectively, and the outer peripheral surfaces of the two conductor wires are coated with the composite conducting elements. When the conductor wires are bent, interiors of the composite conducting elements are not easy to be torn, thus keeping a good conductivity, and when the conductor wires are subjected to electric leakage, currents may flow through the composite conducting elements, and then electrical signals will be transmitted to the outside through the wire bodies in the composite conducting elements, so that electric leakage detection circuits may judge whether the conductor wires are subjected to electric leakage or not. Therefore, the design has a good electric leakage detection performance and is safe to use.

According to some embodiments of the present disclosure, two conductor wires are provided and are respectively a first conductor wire and a second conductor wire, two composite conducting elements are respectively a first composite conducting element and a second composite conducting element, the first conductor wire comprises a first current-carrying core and a first insulating layer coated on an outer peripheral surface of the first current-carrying core, the first composite conducting element is coated on an outer peripheral surface of the first insulating layer, the second conductor wire comprises a second current-carrying core and a second insulating layer coated on an outer peripheral surface of the second current-carrying core, the second composite conducting element is coated on an outer peripheral surface of the second insulating layer, and the first composite conducting element is conductively connected with the second composite conducting element.

According to some embodiments of the present disclosure, the power line further comprises a third conductor wire, wherein the third conductor wire comprises a third current-carrying core and a third insulating layer coated on an outer peripheral surface of the third current-carrying core, the first conductor wire, the second conductor wire and the third conductor wire are arranged side by side, and the third conductor wire is located between the first conductor wire and the second conductor wire.

According to some embodiments of the present disclosure, an outer peripheral surface of the first conductor wire is coated with a fourth insulating layer, and the first composite conducting element is located between the first insulating layer and the fourth insulating layer.

According to some embodiments of the present disclosure, the power line further comprises a first control line, wherein the first control line is located in a space coated by the first insulating layer, and the first control line is conductively connected with the wire body of the first composite conducting element.

The first control line is made of a heat conducting material.

A manufacturing process according to an embodiment in a third aspect of the present disclosure is used for manufacturing the composite conducting element according to any one of the embodiments above, and comprises the following steps of: extending the wire body on at least one surface of the non-woven fabric layer along the length direction of the non-woven fabric layer; and soaking the non-woven fabric layer and the wire body in a liquid non-metallic conducting material to form the conducting layer component covering at least one surface of the non-woven fabric layer.

The manufacturing process according to the embodiment of the present disclosure at least has the following beneficial effects.

For the manufacturing process according to the present disclosure, the wire body is extended along the length direction of the non-woven fabric layer first, and then the non-woven fabric layer and the wire body are soaked in the liquid non-metallic conducting material. Since the non-woven fabric layer is a liquid absorbing material, the liquid conducting material can be well attached to the surface of the non-woven fabric layer and solidified, and coated on the wire body at the same time, so that the wire body is fixed on the surface of the non-woven fabric, and the wire body is tightly contacted with the conducting layer component to conduct electricity. The designed manufacturing process is simple and can improve production efficiency.

Additional aspects and advantages of the present disclosure will be explained in part in the following description, which can become apparent from the following description or be understood through practice of the present disclosure.

### BRIEF DESCRIPTION OF THE DRAWINGS

The above and/or additional aspects and advantages of the present disclosure can become apparent and easy to understand from the description of embodiments in conjunction with the following drawings, where:

FIG. 1 is a schematic structural diagram of an embodiment of a composite conducting element according to the present disclosure;

FIG. 2 is a schematic structural diagram of a cross section of a first embodiment of a power line according to the present disclosure;

FIG. 3 is a schematic structural diagram of a cross section of a second embodiment of the power line according to the present disclosure;

FIG. 4 is a schematic structural diagram of a cross section of a third embodiment of the power line according to the present disclosure; and

FIG. 5 is a schematic diagram of an electric leakage detection circuit.

### REFERENCE NUMERALS

110 refers to non-woven fabric layer; 120 refers to wire body; 130 refers to conducting layer component; 131 refers to first conducting layer; 132 refers to second conducting layer; 210 refers to first current-carrying core; 220 refers to first insulating layer; 230 refers to first composite conducting element; 310 refers to second current-carrying core; 320 refers to second insulating layer; 330 refers to second composite conducting element; 410 refers to third current-carrying core; 420 refers to third insulating layer; 430 refers to fourth insulating layer; 500 refers to protective sheath layer; 610 refers to first control line; 620 refers to fifth insulating layer; 710 refers to second control line; 720 refers to sixth insulating layer; 810 refers to rectification unit; 820 refers to voltage division unit; 830 refers to relay coil; and 840 refers to contact switch.

### DETAILED DESCRIPTION

Embodiments of the present disclosure are described below in detail, illustrations of which are shown in the accompanying drawings, where identical or similar reference numerals denote identical or similar elements or elements having the same or similar functions. The embodiments described below by reference to the accompanying drawings are exemplary and are intended only to explain the present disclosure and are not to be construed as limiting the present disclosure.

In the description of the present disclosure, it should be understood that the orientation or position relationship indicated by the terms “up”, “down”, “front”, “rear”, “left”, “right”, “vertical”, “horizontal”, “top”, “bottom”, “inside”, “outside”, and the like is based on the orientation or position relationship shown in the accompanying drawings, it is only for the convenience of description of the present disclosure and simplification of the description, and it is not to indicate or imply that the indicated device or element must have a specific orientation, and be constructed and operated in a specific orientation. Therefore, the terms shall not be understood as limiting the present disclosure.

In the description of the present disclosure, several means one or more, a plurality of means more than two, greater than, less than, more than, and the like are understood as not including this number, while above, below, within, and the like are understood as including this number. If there are the descriptions of first and second, it is only for the purpose of distinguishing technical features, and should not be understood as indicating or implying relative importance, implicitly indicating the number of the indicated technical features or implicitly indicating the order of the indicated technical features.

In the description of the present disclosure, it should be noted that the terms “installation”, “connected” and “connection” if any shall be understood in a broad sense unless otherwise specified and defined. For example, they may be fixed connection, removable connection or integrated connection; may be mechanical connection or electrical connection; and may be direct connection, or indirect connection through an intermediate medium, and connection inside two elements. The specific meanings of the above terms in the present disclosure can be understood in a specific case by those of ordinary skills in the art.

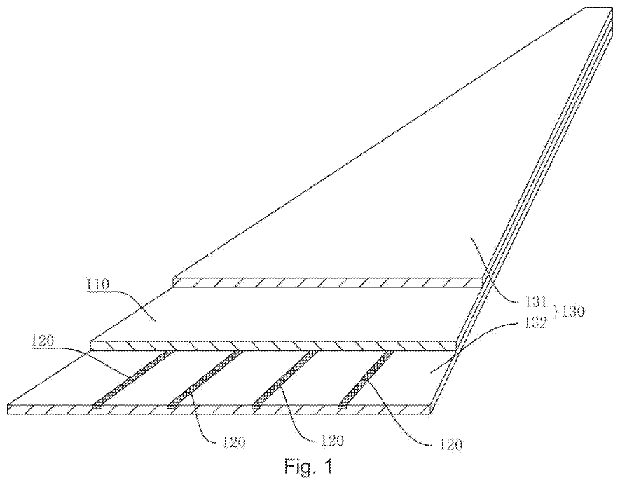

As shown in FIG. 1, a composite conducting element according to an embodiment in a first aspect of the present disclosure comprises a non-woven fabric layer 110, at least one wire body 120 and a non-metallic conducting layer component 130. The wire body 120 is arranged on at least one surface of the non-woven fabric layer 110, and the wire body 120 extends along a length direction of the non-woven fabric layer 110. The conducting layer component 130 covers at least one surface of the non-woven fabric layer 110, the wire body 120 is located between the conducting layer component 130 and the non-woven fabric layer 110, and the wire body 120 is conductively connected with the conducting layer component 130.

The non-woven fabric layer 110 is made of a polyester fiber, terylene fiber (PET for short), and manufactured by a needle punching process, with a good toughness.

The wire body 120 may be a copper wire or an aluminum alloy wire, and a plurality of wire bodies 120 may be provided. Specifically, the non-woven fabric layer 110 is generally cut into strips, the wire bodies 120 extend along the length direction of the non-woven fabric layer 110, and the plurality of wire bodies 120 may be arranged at intervals along a width direction of the non-woven fabric layer 110, so that a control line connected with an external electric leakage detection circuit is easily connected to end portions of the wire bodies 120.

In some embodiments of the present disclosure, the conducting layer component 130 is composed of one of superconducting graphene, superconducting carbon nanometer, superconducting graphite or superconducting carbon black.

The superconducting graphene, the superconducting carbon nanometer, the superconducting graphite and the superconducting carbon black are non-metallic superconducting materials, with a good conductivity. The conducting layer component 130 covers the wire body 120, so as to be tightly contacted with the wire body 120 to conduct electricity. Specifically, during production, the superconducting graphene, the superconducting carbon nanometer, the superconducting graphite and the superconducting carbon black are generally liquid slurries, which are soaked or coated on the surface of the non-woven fabric layer 110 and then solidified. The slurries of the superconducting graphene, the superconducting carbon nanometer, the superconducting graphite and the superconducting carbon black have a certain toughness after solidification, and under support of a non-woven fabric, the conducting layer component 130 is not easy to be broken during bending.

For the composite conducting element according to the present disclosure, the non-woven fabric layer 110 has a good toughness, and the non-metallic conducting layer component 130 covers the non-woven fabric layer 110. When the composite conducting element is bent, the non-woven fabric layer 110 is not easy to be torn, and the conducting layer component 130 can be well supported at the same time, so that the conducting layer component 130 keeps a good conductivity, and the wire body 120 can also be tightly contacted with the conducting layer component 130. Therefore, an electrical signal induced by the conducting layer component 130 can be transmitted to the outside through the wire body 120.

In some embodiments of the present disclosure, the conducting layer component 130 comprises a first conducting layer 131 and a second conducting layer 132, the first conducting layer 131 covers an upper surface of the non-woven fabric layer 110, the second conducting layer 132 covers a lower surface of the non-woven fabric layer 110, the wire body 120 is located between the second conducting layer 132 and the non-woven fabric layer 110, and the wire body 120 is conductively connected with the second conducting layer 132.

Generally speaking, the wire body 120 is arranged on one surface of the non-woven fabric layer 110, while the upper surface of the non-woven fabric layer 110 is covered with the first conducting layer 131 and the lower surface of the non-woven fabric layer 110 is covered with the second conducting layer 132, which can increase an overall strength of the composite conducting element. Meanwhile, the composite conducting element may be applied to form a shielding layer or an electric leakage detection layer of the power line, so as to improve a shielding capability of the shielding layer against an electromagnetic interference signal and an electric leakage detection accuracy at the same time.

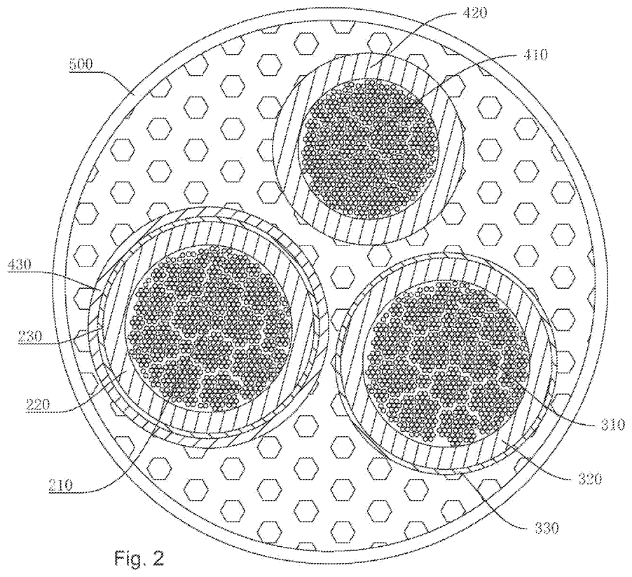

A power line according to an embodiment in a second aspect of the present disclosure, as shown in FIG. 2 to FIG. 4, is internally provided with at least two conductor wires, wherein a partial or whole outer peripheral surface of each conductor wire is coated with the composite conducting element disclosed by any one of the embodiments above.

The composite conducting element may be strip-shaped, and the composite conducting element is spirally wound on the outer peripheral surface of the conductor wire.

In the embodiment that the wire body 120 is only arranged on one surface of the non-woven fabric layer 110, the wire body may be located on one side of the non-woven fabric layer 110 close to the conductor wire, or located on one side of the non-woven fabric layer 110 far away from the conductor wire.

For the power line according to the present disclosure, two conductor wires may be connected to two electrodes of a direct-current power supply or two phases of an alternating-current power supply respectively, and the outer peripheral surfaces of the two conductor wires are coated with the composite conducting elements. When the conductor wires are bent, interiors of the composite conducting elements are not easy to be torn, thus keeping a good conductivity, and when the conductor wires are subjected to electric leakage, currents may flow through the composite conducting elements, and then electrical signals will be transmitted to the outside through the wire bodies 120 in the composite conducting elements, so that the electric leakage detection circuits may judge whether the conductor wires are subjected to electric leakage or not. Therefore, the design has a good electric leakage detection performance and is safe to use.

In some embodiments of the present disclosure as shown in FIG. 2 to FIG. 4, two conductor wires are provided and are respectively a first conductor wire and a second conductor wire, and two composite conducting elements are respectively a first composite conducting element 230 and a second composite conducting element 330. The first conductor wire comprises a first current-carrying core 210 and a first insulating layer 220 coated on an outer peripheral surface of the first current-carrying core 210, and the first composite conducting element 230 is coated on an outer peripheral surface of the first insulating layer 220. The second conductor wire comprises a second current-carrying core 310 and a second insulating layer 320 coated on an outer peripheral surface of the second current-carrying core 310, the second composite conducting element 330 is coated on an outer peripheral surface of the second insulating layer 320, and the first composite conducting element 230 is conductively connected with the second composite conducting element 330.

The first current-carrying core 210 may be connected with an L phase of the alternating-current power supply, and the second current-carrying core 310 may be connected with an N phase of the alternating-current power supply. The first composite conducting element 230 can shield power transmission of the first current-carrying core 210, and the second composite conducting element 330 can shield power transmission of the second current-carrying core 310. Meanwhile, when the power transmission of the first current-carrying core 210 is subjected to electric leakage to the outside, a current may break through the first insulating layer 220 and then pass through the conducting layer component 130 of the first composite conducting element 230, and then be transmitted to the external electric leakage detection circuit through the wire body 120. Similarly, when the power transmission of the second current-carrying core 310 is subjected to electric leakage to the outside, a current may break through the second insulating layer 320 and then pass through the conducting layer component 130 of the second composite conducting element 330, and then be transmitted to the external electric leakage detection circuit through the wire body 120.

Both the first current-carrying core 210 and the second current-carrying core 310 may formed by twisting conducting filaments made of metal, such as copper and aluminum, or alloy.

In some embodiments of the present disclosure, both the first insulating layer 220 and the second insulating layer 320 may be made of plastic, rubber or an irradiated ethylene propylene material. Specifically, the plastic may be a PVC material, the rubber may be a CPE synthetic rubber material, and the irradiated ethylene-propylene material may be ethylene propylene diene monomer rubber. Compared with a traditional irradiated chlorinated polyethylene insulating material, the irradiated ethylene-propylene material has better insulation performance and waterproof performance.

It should be noted that the power line further comprises a protective sheath layer 500, the conductor wires are coated inside the protective sheath layer 500, and fillers may be arranged between multiple conductor wires and between an interior of the protective sheath layer 500 and outer walls of the conductor wires. Specifically, the fillers may be aramid fibers.

The protective sheath layer 500 may be made of plastic, rubber or an irradiated levapren material (EVM). Specifically, the plastic may be a PVC material, the rubber may be a CPE synthetic rubber material, and the irradiated levapren material (EVM) may be ethylene ethyl acetate rubber, wherein the irradiated levapren material (EVM) is a low-smoke halogen-free material. Compared with the traditional irradiated chlorinated polyethylene insulating material, the irradiated levapren material (EVM) has better flame retardant performance and environmental protection performance.

Materials selected for the protective sheath layer 500 as well as the first insulating layer 220 and the second insulating layer 320 may have various embodiments, for example:
the first insulating layer 220 and the second insulating layer 320 are made of the irradiated ethylene propylene, and the protective sheath layer 500 is made of the plastic or the rubber;
the first insulating layer 220 and the second insulating layer 320 are made of the plastic or the rubber, and the protective sheath layer 500 is made of the irradiated levapren material (EVM); and
the first insulating layer 220 and the second insulating layer 320 are made of the irradiated ethylene propylene, and the protective sheath layer 500 is made of the irradiated levapren material (EVM).

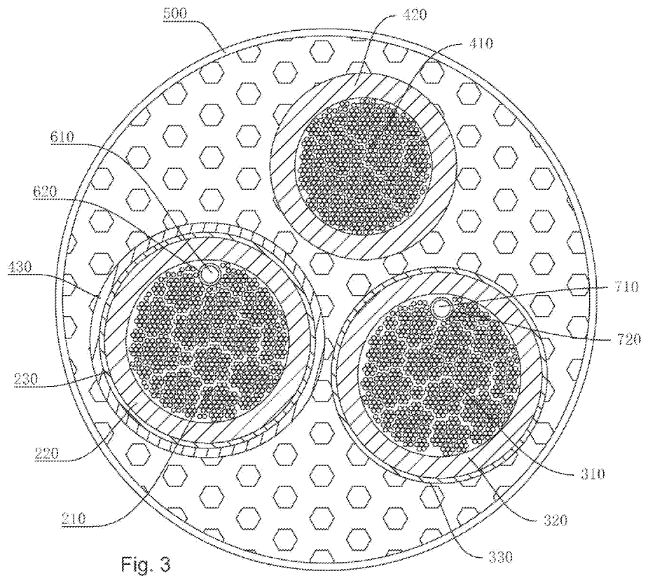

In some embodiments of the present disclosure, as shown in FIG. 2 and FIG. 3, an outer peripheral surface of the first conductor wire is coated with a fourth insulating layer 430, and the first composite conducting element 230 is located between the first insulating layer 220 and the fourth insulating layer 430.

Since surfaces of the first composite conducting element 230 and the second composite conducting element 330 are both conductive, and the first conductor wire and the second conductor wire are located in the protective sheath layer 500, and there is a possibility that the first composite conducting element 230 and the second composite conducting element 330 are contacted with each other to conduct electricity. Therefore, the fourth insulating layer 430 is coated on the first composite conducting element 230, and the fourth insulating layer 430 can insulate the first composite conducting element 230 from the second composite conducting element 330, thereby electric leakage detection being more stable and accurate.

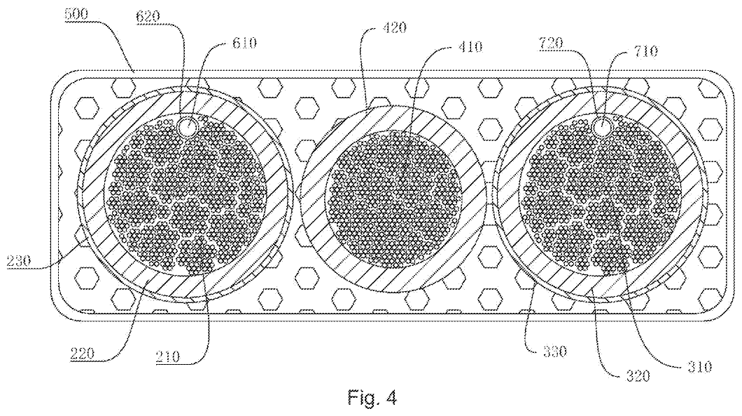

In some embodiments of the present disclosure, as shown in FIG. 2, FIG. 3 and FIG. 4, the power line further comprises a third conductor wire, wherein the third conductor wire comprises a third current-carrying core 410 and a third insulating layer 420 coated on an outer peripheral surface of the third current-carrying core 410.

The third current-carrying core 410 may be connected with a ground wire in the alternating-current power supply, so that the power line is more stable and safer for power transmission. Similarly, the third conductor wire is also coated in the protective sheath layer 500.

Specifically, the third current-carrying core 410 may also be formed by twisting conducting filaments made of metal, such as copper and aluminum, or alloy, and the third insulating layer 420 may be made of the same material as the first insulating layer 220 and the second insulating layer 320, such as the plastic, the rubber or the irradiated ethylene propylene material.

In some embodiments of the present disclosure, as shown in FIG. 4, the first conductor wire, the second conductor wire and the third conductor wire are arranged side by side, and the third conductor wire is located between the first conductor wire and the second conductor wire. The first composite conducting element 230 on the first conductor wire and the second composite conducting element 330 on the second conductor wire are separated by the third insulating layer 420 of the third conductor wire. Since the first conductor wire, the second conductor wire and the third conductor wire are arranged side by side, the first composite conducting element 230 and the second composite conducting element 330 are not easy to be contacted, so that it is unnecessary to coat the fourth insulating layer 430 on the first composite conducting element 230 or the second composite conducting element 330, thereby saving a cost.

In some embodiments of the present disclosure, the power line further comprises a first control line 610, wherein the first control line 610 is located in a space coated by the first insulating layer 220, and the first control line 610 is conductively connected with the wire body of the first composite conducting element 230.

The first control line 610 is used for connecting with the external electric leakage detection circuit, so that the electric leakage detection circuit acquires the electrical signal capable of indicating whether electric leakage occurs or not and transmitted by the wire body 120. It can be understood that an outer peripheral surface of the first control line 610 is coated with a fifth insulating layer 620. Since the first current-carrying core 210 is internally provided a certain clearance space, the first control line 610 is located in the space covered by the first insulating layer 220, so that an internal structure of the first conductor wire may be more compact. Compared with arrangement of the first control line 610 outside the first insulating layer 220, an external space is not occupied, and meanwhile, the first control line may not collide with other components such as the second conductor wire and the third conductor wire when the power line moves or is bent, thus reducing a probability of wear.

Similarly, the power line may further comprise a second control line 710, wherein the second control line 710 is located in a space coated by the second insulating layer 320, and the second control line 710 is conductively connected with the wire body 120 of the second composite conducting element 330.

The second control line 710 is used for connecting with the external electric leakage detection circuit, so that the electric leakage detection circuit acquires the electrical signal capable of indicating whether electric leakage occurs or not and transmitted by the wire body 120. It can be understood that an outer peripheral surface of the second control line 710 is coated with a sixth insulating layer 720. Since the second current-carrying core 310 is internally provided a certain clearance space, the second control line 710 is located in the space covered by the second insulating layer 320, so that an internal structure of the second conductor wire may be more compact. Compared with arrangement of the second control line 710 outside the second insulating layer 320, an external space is not occupied, and meanwhile, the second control line may not collide with other components such as the first conductor wire and the third conductor wire when the power line moves or is bent, thereby reducing a probability of wear.

Specifically, the first control line 610 and the second control line 710 are both made of a heat-conducting material. By conducting heat of the first current-carrying core 210 and heat of the second current-carrying core 310 through the first control line 610 and the second control line 710 respectively, temperatures of the first current-carrying core 210 and the second current-carrying core 310 may be judged by collecting temperatures of the first control line 610 and the second control line 710 through a temperature detection component from the outside. When the temperatures are abnormal, reasonable measures such as stopping power supply may be taken to improve a safety level.

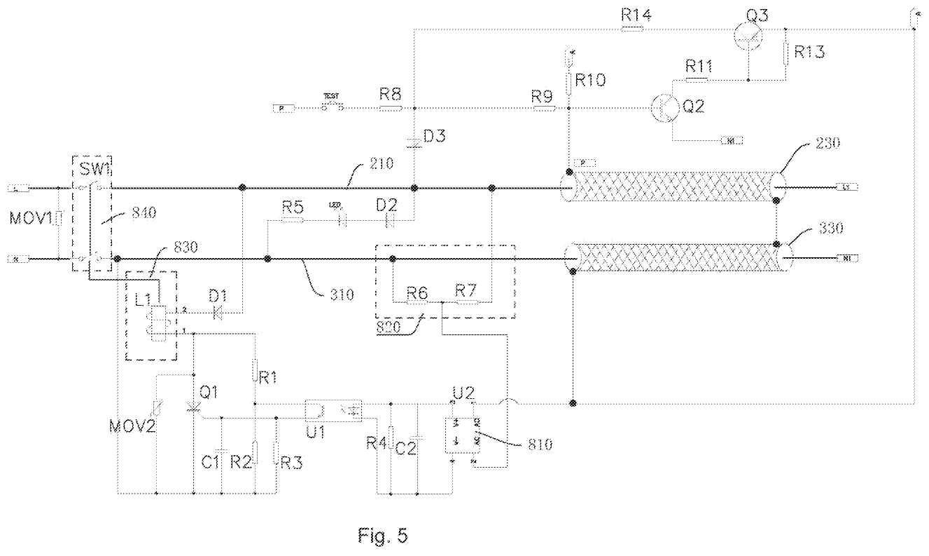

The electric leakage detection circuit may have various embodiments, for example, as shown in FIG. 5, the electric leakage detection circuit comprises a rectification unit 810, a voltage division unit 820, a photoelectric coupler U1, a silicon controlled rectifier Q1 and a relay. The relay comprises a relay coil 830 and a contact switch 840 capable of being driven by the relay coil 830 to switch on and off. The contact switch 840 comprises a first switch and a second switch. For example, the first current-carrying core 210 may be connected with the L phase of the alternating-current power supply, and the second current-carrying core 310 may be connected with the N phase of the alternating-current power supply. The first switch is arranged on the first current-carrying core 210 to control switching on and off of the first current-carrying core 210, and the second switch is arranged on the second current-carrying core 310 to control switching on and off of the second current-carrying core 310.

The voltage division unit 820 comprises a resistor R6 and a resistor R7. One end of the resistor R6 is electrically connected with the second current-carrying core 310, one end of the resistor R7 is electrically connected with the first current-carrying core 210, and the other end of the resistor R6 is electrically connected with the other end of the resistor R7 and one phase of an alternating-current input terminal of the rectification unit 810.

It should be noted that the first composite conducting element 230 coated on the outer peripheral surface of the first insulating layer 220 and the second composite conducting element 330 coated on the outer peripheral surface of the second insulating layer 320 have certain lengths. One end of the first composite conducting element 230 is conductively connected with one end of the second composite conducting element 330, and the other phase of the alternating-current input terminal of the rectification unit 810 is electrically connected with the other end of the first composite conducting element 230 and the other end of the second composite conducting element 330 respectively.

One electrode of a direct-current output terminal of the rectification unit 810 is connected with an anode of a light emitter of the photoelectric coupler U1, and the other electrode of the direct-current output terminal of the rectification unit 810 is connected with a cathode of the light emitter of the photoelectric coupler U1. A positive electrode of a light receiver of the photoelectric coupler U1 is connected with one end of the relay coil 830 and an input electrode of the silicon controlled rectifier Q1 respectively through the resistor R1, and a negative electrode of the light receiver of the photoelectric coupler U1 is connected with a controlled electrode of the silicon controlled rectifier Q1. Moreover, the negative electrode of the light receiver of the photoelectric coupler U1 is connected with the second current-carrying core 310 through the resistor R2, the other end of the relay coil 830 is connected with a negative electrode of a diode D1, a positive electrode of the diode D1 is connected with the first current-carrying core 210, and an output end of the silicon controlled rectifier Q1 is connected with the second current-carrying core 310.

Specifically, the rectification unit 810 is selected from a conventional full-bridge rectification structure or a half-bridge rectification structure.

When any one of the first conductor wire or the second conductor wire is subjected to electric leakage, the first current-carrying core 210 conducts electricity with the first composite conducting element 230, or the second current-carrying core 310 conducts electricity with the second composite conducting element 330, and the silicon controlled rectifier Q1 is switched on, so that the relay coil 830 may control the contact switch 840 to switch off.

In the structure of the electric leakage detection circuit above, even if line breakage occurs in any one of the first composite conducting element 230 and the second composite conducting element 330, an electric leakage signal can be fed back from the other one of the first composite conducting element 230 and the second composite conducting element 330 to the other phase of the alternating-current input terminal of the rectification unit 810, thereby triggering the contact switch 840 to switch off.

A manufacturing process according to an embodiment in a third aspect of the present disclosure is used for manufacturing the composite conducting element according to any one of the embodiments above, and comprises the following steps of: extending the wire body 120 on at least one surface of the non-woven fabric layer 110 along the length direction of the non-woven fabric layer 110; and soaking the non-woven fabric layer 110 and the wire body 120 in a liquid non-metallic conducting material to form the conducting layer component 130 covering at least one surface of the non-woven fabric layer 110.

The non-metallic conducting material may be one of superconducting graphene, superconducting carbon nanometer, superconducting graphite or superconducting carbon black, and can form liquid slurry. Moreover, compared with a liquid state of a metallic conducting material, the non-metallic conducting material has a low temperature, and may not damage the non-woven fabric layer 110.

For the manufacturing process according to the present disclosure, the wire body 120 is extended along the length direction of the non-woven fabric layer 110 first, and then the non-woven fabric layer 110 and the wire body 120 are soaked in the liquid non-metallic conducting material. Since the non-woven fabric layer 110 is a liquid absorbing material, the liquid conducting material can be well attached to the surface of the non-woven fabric layer 110 and solidified, and coated on the wire body 120 at the same time, so that the wire body 120 is fixed on the surface of the non-woven fabric, and the wire body 120 is tightly contacted with the conducting layer component 130 to conduct electricity. The designed manufacturing process is simple and can improve production efficiency.

Various technical features of the above embodiments may be combined randomly, and in order to simplify the description, possible combinations of various technical features in the above embodiments are not all described. However, as long as the combinations of these technical features have no contradiction, the combinations of these technical features should be considered as falling into the scope recorded by the specification.

Although the embodiments of the present disclosure have been shown and described, those of ordinary skills in the art may understand that various changes, modifications, substitutions and variations may be made to these embodiments without departing from the principle and purpose of the present disclosure, and the scope of the present disclosure is defined by the claims and their equivalents.

What is claimed is:

1. A composite conducting element, comprising:
a non-woven fabric layer;
at least one wire body arranged on at least one surface of the non-woven fabric layer, the wire body extending along a length direction of the non-woven fabric layer; and
a non-metallic conducting layer component covering at least one surface of the non-woven fabric layer, the wire body being located between the conducting layer component and the non-woven fabric layer, and the wire body being conductively connected with the conducting layer component.

2. The composite conducting element of claim 1, wherein the conducting layer component comprises a first conducting layer and a second conducting layer, the first conducting layer covers an upper surface of the non-woven fabric layer, the second conducting layer covers a lower surface of the non-woven fabric layer, the wire body is located between the second conducting layer and the non-woven fabric layer, and the wire body is conductively connected with the second conducting layer.

3. The composite conducting element of claim 1, wherein the conducting layer component is composed of one of superconducting graphene, superconducting carbon nanometer, superconducting graphite or superconducting carbon black.

4. A power line internally provided with at least two conductor wires, wherein a partial or whole outer peripheral surface of each conductor wire is coated with a composite conducting element, the composite conducting element comprising:
a non-woven fabric layer;
at least one wire body arranged on at least one surface of the non-woven fabric layer, the wire body extending along a length direction of the non-woven fabric layer; and
a non-metallic conducting layer component covering at least one surface of the non-woven fabric layer, the wire body being located between the conducting layer component and the non-woven fabric layer, and the wire body being conductively connected with the conducting layer component.

5. The power line of claim 4, wherein the two conductor wires are provided and are respectively a first conductor wire and a second conductor wire, two composite conducting elements are provided and are respectively a first composite conducting element and a second composite conducting element, the first conductor wire comprises a first current-carrying core and a first insulating layer coated on an outer peripheral surface of the first current-carrying core, the first composite conducting element is coated on an outer peripheral surface of the first insulating layer, the second conductor wire comprises a second current-carrying core and a second insulating layer coated on an outer peripheral surface of the second current-carrying core, the second composite conducting element is coated on an outer peripheral surface of the second insulating layer, and the first composite conducting element is conductively connected with the second composite conducting element.

6. The power line of claim 5, further comprising a third conductor wire, wherein the third conductor wire comprises a third current-carrying core and a third insulating layer coated on an outer peripheral surface of the third current-carrying core, the first conductor wire, the second conductor wire and the third conductor wire are arranged side by side, and the third conductor wire is located between the first conductor wire and the second conductor wire.

7. The power line of claim 5, wherein a fourth insulating layer is coated on an outer peripheral surface of the first conductor wire, and the first composite conducting element is located between the first insulating layer and the fourth insulating layer.

8. The power line of claim 5, further comprising a first control line, wherein the first control line is located in a space coated by the first insulating layer, and the first control line is conductively connected with the wire body of the first composite conducting element.

9. The power line of claim 8, wherein the first control line is made of a heat conducting material.

10. A manufacturing process used for manufacturing a composite conducting element, the composite conducting element comprising: a non-woven fabric layer; at least one wire body arranged on at least one surface of the non-woven fabric layer, the wire body extending along a length direction of the non-woven fabric layer; and a non-metallic conducting layer component covering at least one surface of the non-woven fabric layer, the wire body being located between the conducting layer component and the non-woven fabric layer, and the wire body being conductively connected with the conducting layer component,
the manufacturing process comprising:
extending the wire body on at least one surface of the non-woven fabric layer along the length direction of the non-woven fabric layer; and
soaking the non-woven fabric layer and the wire body in a liquid non-metallic conducting material to form the conducting layer component covering at least one surface of the non-woven fabric layer.
